(19) United States
(12) Patent Application Publication
(10) Pub. No.: US 2009/0073507 A1
(43) Pub. Date: Mar. 19, 2009

(54) DOCUMENT READING APPARATUS AND DOCUMENT READING SYSTEM

(75) Inventor: Yoshio Fukuda, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/200,107

(22) Filed: Aug. 28, 2008

(30) Foreign Application Priority Data
Sep. 18, 2007 (JP) 2007-240605
Feb. 27, 2008 (JP) 2008-046019

(51) Int. Cl. H04N 1/04

(52) U.S. Cl. 358/474

(57) ABSTRACT

It is intended to perform area specification to carry out arbitrary image processing by an easy operation without spoiling a document. An document reading apparatus includes a heater for heating the document in a document transport path in the upstream side of a document reading portion. By comparing image data read by the image reading portion without performing heating by the heater and image data read by the image reading portion after performing the heating by the heater, drawn image data drawn by a coloring material which gets denatured and decolorizes when heated is extracted. Then, a specified area surrounded by the extracted drawn image data is determined and specific image processing based on an operation input by a user is applied to image data in the specified area.

### CROSS-NOTING PARAGRAPH

This Non-provisional application claims priority under 35 U.S.C. §119(a) on Patent Application No. 2007-240605 filed in JAPAN on Sep. 18, 2007 and Patent Application No. 2008-046019 filed in Japan on Feb. 27, 2008, the entire contents of which are hereby incorporated herein by reference.

### FIELD OF THE INVENTION

The present invention relates to a document reading apparatus and a document reading system, more specifically to a document reading apparatus and a document reading system wherein arbitrary image processing can be performed for a document image in an area specified by a user.

### BACKGROUND OF THE INVENTION

A document reading apparatus which reads an image of a document to generate image data has been widely known. Moreover, an apparatus that can perform arbitrary image processing for read document image data has been known. Examples of the image processing include image erasure, color change, zooming, enhancement processing, and the like. In addition, the image processing also includes image edit such as image synthesis.

When performing the image processing as described above, if it is possible that a part of an area in the read image data is specified and arbitrary image processing is performed for the image data in the specified area, a user is able to obtain higher convenience.

For example, Japanese Laid-Open Patent Publication No. 03-017787 discloses an intra-frame area detecting device wherein an area in a specific frame is detected from an image signal so as to facilitate edit for the image in the detected intra-frame area. In addition, Japanese Laid-Open Patent Publication No. 2006-063238 discloses thermally erasable ink which is decolorized when it is heated to a specific temperature.

Conventional document reading apparatuses involve difficulties, when a part of an area of a document is specified and image processing, such as image erasure, color change, zooming, and enhancement processing, is performed for the specified area. For example, there is a problem that, when writing into a document itself to specify an area, the document is spoiled.

In addition, there is a method wherein a document image is once read, image data thereof is displayed on a display screen, and an operation is performed for the display screen, so that an area can be specified, however, with this method, the document is not spoiled, but processing of editing read image data is required, posing a problem that the operation is made troublesome.

### SUMMARY OF THE INVENTION

An object of the present invention is to provide a document reading apparatus and a document reading system wherein an area specification to execute arbitrary image processing is carried out by an easy operation without spoiling a document.

Another object of the present invention is to provide a document reading apparatus including an image reading portion for reading an image of a document to generate image data, comprising: a heater for heating the document in a document transport path in a upstream side of the image reading portion; and an image data extraction portion which compares image data read by the image reading portion without performing heating by the heater and image data read by the image reading portion after performing the heating by the heater, to thereby extract drawn image data drawn by a coloring material which gets denatured and decolorizes when heated.

Another object of the present invention is to provide the document reading apparatus, wherein when the image data extraction portion performs extraction of the drawn image data, the image reading portion performs an operation of reading the same document twice in a row, and in a first document image reading, the document image is read without performing heating by the heater and in a second document image reading, the document image is read after performing the heating by the heater.

Another object of the present invention is to provide a document reading apparatus including an image reading portion for reading an image of a document to generate image data, comprising:a heater for heating the document in a document transport path in a downstream side of the image reading portion; and an image data extraction portion for extracting drawn image data drawn by a coloring material of a specific color from the image data read by the image reading portion.

Another object of the present invention is to provide the document reading apparatus, further comprising: a specified area determination portion for determining, based on the drawn image data extracted by the image data extraction portion, a specified area surrounded by the drawn image data, and an image processing portion for applying specified image processing for image data in the specified area determined by the specified area determination portion.

Another object of the present invention is to provide the document reading apparatus, further comprising: a display portion for displaying the image data read by the image reading portion without performing heating by the heater and the image data read by the image reading portion after performing the heating by the heater, wherein the image processing portion receives an operation input to confirm the image data displayed on the display portion and applies the specified image processing after the operation input.

Another object of the present invention is to provide the document reading apparatus, further comprising: a display portion for displaying the image data read by the image reading portion, wherein the image processing portion receives an operation input to confirm the image data displayed on the display portion and applies the specified image processing after the operation input.

Another object of the present invention is to provide the document reading apparatus, wherein the heater is provided so as to be able to heat both of a front and a rear faces of the document.

Another object of the present invention is to provide the document reading apparatus, wherein the heater heats the front face and the rear face of the document selectively.

Another object of the present invention is to provide the document reading apparatus, wherein the heater is composed of a first heater for heating the front face of the document and a second heater for heating the rear face of the document, and the first and the second heaters are disposed so as to face each other across a transport path of the document.

Another object of the present invention is to provide the document reading apparatus, wherein a transport speed of the document when reading the document image after performing the heating by the heater is lower than a transport speed when reading the document image without performing the heating by the heater.

Another object of the present invention is to provide the document reading apparatus, wherein when a page number of the document in which the drawn image data is to be extracted is specified, the heater is controlled so as to heat the document of the specified page number.

Another object of the present invention is to provide a document reading system, comprising: a document reading apparatus which has an image reading portion for reading an image of a document to generate image data and a heater for heating the document and erasing a drawn part on the document, that is drawn by a coloring material which gets denatured and decolorizes when heated; a drawn image data extraction portion for extracting drawn image data drawn by the coloring material; a specified area determination portion for determining, based on the drawn image data extracted by the image data extraction portion, a specified area surrounded by the drawn image data; and an image processing portion for applying specified image processing for image data in the specified area determined by the specified area determination portion.

Another object of the present invention is to provide the document reading system, wherein the image processing portion erases the image data in the specified area to perform synthesizing with another image data.

Another object of the present invention is to provide the document reading system, wherein the image processing portion performs synthesizing by automatically zooming the another image data so as to match the specified area in size.

Another object of the present invention is to provide the document reading system, wherein the image processing portion performs synthesizing a plurality of the another image data with a plurality of the specified areas in a predetermined order.

Another object of the present invention is to provide the document reading system, wherein the image processing portion converts text data into bitmap data and performs synthesizing the converted bitmap data as the another image data with the specified area.

Another object of the present invention is to provide the document reading system, wherein the image processing portion performs synthesizing the another image data showing that an original image is concealed with the specified area.

### BRIEF DESCRIPTION OF THE DRAWINGS

FIG. 1 is a view showing an example of the overall structure of a document reading system according to the present invention;

FIG. 2 is a schematic structural view for illustrating an embodiment of a document reading apparatus according to the present invention;

FIG. 3 is a block diagram schematically showing a main part of the electric structure in an embodiment of the document reading apparatus according to the present invention;

FIG. 4 is a flowchart for illustrating an example of processing of determining a specified area in the document reading apparatus according to the present invention;

FIGS. 5A to 5C are views for specifically illustrating an example of processing of determining a specified area;

FIGS. 6A to 6C are views for illustrating an example of processing of determining a surrounded area of drawn image data;

FIG. 7 is a schematic structural view for illustrating another embodiment of the document reading apparatus according to the present invention;

FIG. 8 is a view for illustrating another example of processing of determining a specified area in the document reading apparatus of the present invention; and

FIGS. 9A to 9C are views for illustrating an example of image processing for image data of a specified area.

### PREFERRED EMBODIMENTS OF THE INVENTION

(Overall Structure of a System)

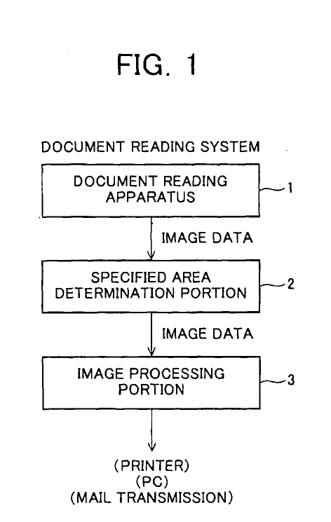

FIG. 1 is a view showing an example of the overall structure of a document reading system according to the present invention. The document reading system has a document reading apparatus 1, a specified area determination portion 2, and an image processing portion 3.

The document reading apparatus 1 reads a document image and generates image data. The specified area determination portion 2 determines a specified area surrounded by predetermined drawn image data from the image data read by the document reading apparatus 1. The drawn image data is image data drawn by a coloring material which gets denatured and decolorizes when it is heated, or image data drawn by a coloring material of a specific color.

The image processing portion 3 performs specified image processing for the image data in the specified area determined by the specified area determination portion 2. As the image processing, for example, image edit processing such as image erasure, color change, zooming, enhancement processing, or image synthesis can be carried out.

As the image edit processing such as image synthesis, for example, processing of erasing image data of a specified area to synthesize another image data can be performed, and in this case, processing of synthesizing by automatically zooming another image data so as to match with the specified area in size, processing of synthesizing a plurality of image data in a predetermined order with a plurality of specified areas, processing of synthesizing bit map data converted from text data with the specified area, processing of synthesizing image data showing that an original image is concealed with the specified area, and the like can be performed.

In the system structural example shown in FIG. 1, the specified area determination portion 2 and the image processing portion 3 that are provided out of the document reading apparatus 1 may be included, for example, in a control portion of a digital multi-functional peripheral provided with the document reading apparatus 1, or in an information processing apparatus (such as a PC) connected to the document reading apparatus 1. Moreover, the specified area determination portion 2 and the image processing portion 3 may be provided so as to be incorporated in the document reading apparatus 1. In this case, the structure of the embodiment of the document reading apparatus according to the present invention is applicable. The image data after image processing can be printed by a printer, be displayed and subjected to image processing by a PC, or be transmitted by a mail.

### Embodiment 1

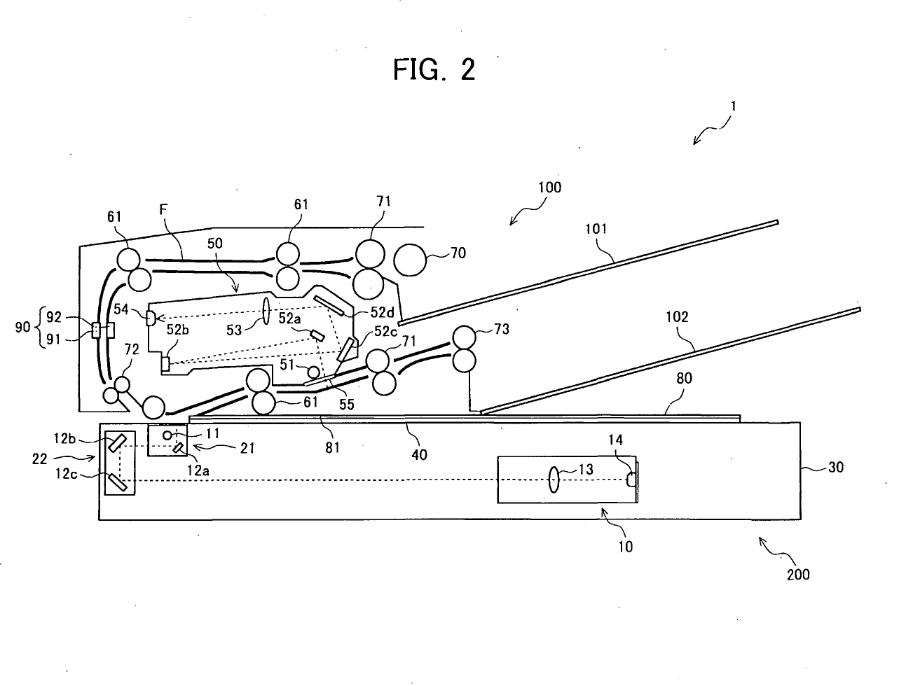

FIG. 2 is a schematic structural view for illustrating an embodiment of the document reading apparatus according to the present invention. The document reading apparatus 1 of the present embodiment is provided above a copier (not shown), and is mainly composed of an ADF (Auto Document Feeder) 100 which contains second image reading means 50 therein, and a main scanning portion 200 which contains first image reading means 10 therein.

The ADF 100 and the main scanning portion 200 are joined to each other by a hinge (not shown), and the ADF 100 can be opened or closed with respect to the main scanning portion 200 by the rotational movement of the hinge.

The main scanning portion 200 includes mainly a housing 30, a platen table 40 made of a transparent glass plate, and the first image reading means 10 contained in the housing 30.

The first image reading means 10 is of an optical reduction system constituted of a light source unit 21 which holds a light source 11 and a first mirror 12a, a mirror unit 22 which holds a second mirror 12b and a third mirror 12c, a lens 13, and a CCD 14.

The main scanning portion 200 can cope with both systems of a document fixing system in which an image of a document placed on the platen table 40 by a user is read, and a document moving system in which an image of a document is read while the document is automatically transported by the ADF 100.

In a case where a document image is read by the document fixing system, the light source unit 21 and the mirror unit 22 are moved to home positions, respectively, according to the document fixing system. FIG. 2 shows a state where the light source unit 21 and the mirror unit 22 are located at the home positions.

Thereafter, the light source unit 21 is moved at a constant speed in a sub scanning direction (lateral direction with respect to a sheet surface) while irradiating the document with light to scan the image of the document, and at the same time, the mirror unit 22 is moved at a movement speed half the movement speed of the light source unit 21 also in the sub scanning direction.

The light irradiated by the light source unit 21 and reflected on the document is reflected by the first mirror 12a disposed in the light source unit 21, and thereafter the optical path is converted at an angle of 180 degrees by the second and third mirrors 12b and 12c in the mirror unit 22. Then, the light reflected by the third mirror 12c is focused on the CCD 14 through the lens 13, to be converted into electric image data.

On the other hand, in a case where a document image is read by the document moving system, the light source unit 21 and the mirror unit 22 stay at the home positions shown in FIG. 2, and in this state, the document transported over the home positions by the ADF 100 is scanned by the light from the light source 11. The light reflected on a surface of the document is reflected by the first mirror 12a, and thereafter the optical path is converted at an angle of 180 degrees by the second and third mirrors 12b and 12c in the mirror unit 22, and the light is focused on the CCD 14 through the lens 13, to be converted into electric image data, like in the above-described document fixing system.

As shown in FIG. 2, the ADF 100 includes mainly a taking-in roller 70 for taking documents placed on a document stacker 101 one by one into the ADF 100, a plurality of pairs of transport rollers 71 for transporting the taken-in documents along a document transport path F, a resist roller 72 for adjusting a timing of feeding sheets, and a paper discharge roller 73 for discharging the document whose image has been read to a paper discharge tray 102. In addition, the ADF 100 includes the unitized second image reading means 50 contained inside of the document transport path F curved in a substantial U shape.

The second image reading means 50 is of an optical reduction system constituted of a first mirror 52a, a second mirror 52b, a third mirror 52c, a fourth mirror 52d, a lens 53, and a CCD 54, and these components are unified into one assembly and contained in a housing for unit 600.

Note that, in the second image reading means 50, the light source 51, the lens 53, and the CCD 54 are the same as the components constituting the first image reading means 10.

The second image reading means 50 reads an image formed on a rear side of the document transported on the document transport path F, when a user requires double-sided reading. Specifically, after an image formed on the front side of the document is read by the first image reading means 10, the document is transported toward the paper discharge tray 102 along the document transport path F. The document passes under the light source 51 in the second image reading means 50.

At this time, the light source 51 in the second image reading means 50 irradiates the rear side of the document with the light. The light reflected on the rear side of the document passes through a reading window 55 formed by a transparent member such as a glass, the optical path thereof is sequentially converted by the first to fourth mirrors 52a, 52b, 52c and 52d, and then, the light is focused on the CCD 54 through the lens 53, to be thus converted into electric image data. The first image reading means 10 and the second image reading means 50 correspond to an image reading portion of the present invention for reading a document image to generate image data.

Moreover, the lower surface of the ADF 100 serves as a document pressing plate 80 for pressing a document to be read that is placed on the platen table 40 of the main scanning portion 200. The pressing plate 80 becomes a lid 81 at a part being faced to the light source 11 of the first image reading means 10.

In a transport path of the ADF 100, a heater unit composed of a first heater 91 and a second heater 92 is provided. These first and second heaters 91 and 92 are provided so as to erase decoloring ink applied to a document, wherein the first heater 91 erases the decoloring ink on a front side of the document and the second heater 92 erases the decoloring ink on a rear side of the document. The first heater 91 and the second heater 92 are disposed so as to face each other across the transport path of the document. Thus, it is possible to heat the document efficiently from front and rear sides without dispersing the heat.

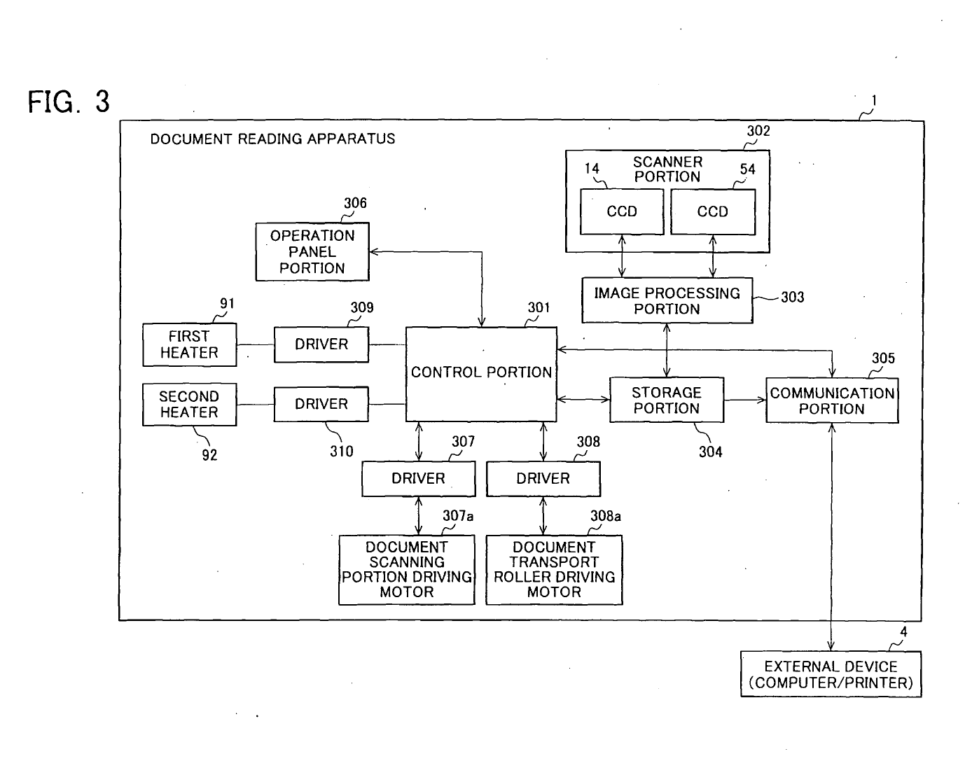

FIG. 3 is a block diagram schematically showing a main part of the electric structure in an embodiment of the document reading apparatus.

The document reading apparatus 1 of the present embodiment mainly includes a control portion 301, a scanner portion 302, an image processing portion 303, a storage portion 304, a communication portion 305, an operation panel portion 306, a driver 307 for driving and controlling a document scanning portion driving motor 307a, and a driver 308 for driving and controlling a document transport roller driving motor 308a.

The control portion 301 is a part which manages the operation control of a whole of the apparatus, and is composed of a CPU, a ROM, a RAM and the like (not shown). An image data extracting portion, a specified area determination portion, and an image processing portion of the present invention are realized by the control portion 301.

The scanner portion 302 constitutes the scanning optical system of the first and second image reading means and 50 shown in FIG. 2. Although each of the CCDs 14 and 54 of the first and second image reading means 10 and 50 is defined as a CCD (Charge Coupled Devices) of an optical reduction system in the above description, each of which may be a CIS (Contact Image Sensor) of an equi-magnification optical system.

The image processing portion 303 converts optical data read by the first image reading means 10 or the second image reading means 50 into electric image data for each page.

The storage portion 304 is composed of, for example, a RAM, an EEPROM, a hard disc, an MO and the like, and stores data being controlled that is controlled by the control portion 301, various kinds of input instruction contents, image data of documents read by the scanner portion 302 and the like.

The communication portion 305 performs two-way communication with an external device 4 such as a computer and a printer that are connected thereto, and transmits data which is subjected to image processing in the image processing portion 303 to the external device 4. Moreover, the communication portion 305 includes a memory in which data transmitted from the external device 4 is developed into data which can be treated by the present apparatus.

The operation panel portion 306 (not shown) is disposed in front of the document reading apparatus 1 shown in FIG. 2. Specifically, the main scanning portion 200 is extended to the position over the front side of the ADF 100, and the operation panel portion 306 is disposed on the upper portion thereof. The operation panel portion 306 is used to input an operation mode at the time of reading a document (specification of one-sided reading, double-sided reading, etc.) and the like.

The document scanning portion driving motor 307a is a motor for moving the light source unit 21 and the mirror unit 22 in a sub scanning direction at an appropriate speed when a document image is read by a document fixing system, and is appropriately driven and controlled by the driver 307 in accordance with the control of the control portion 301.

The document transport roller driving motor 308a is a motor for driving each roller including the taking-in roller 70, the transport roller 71, the resist roller 72, and the paper discharge roller 73 that are disposed in the document transport path F, and is appropriately driven and controlled by the driver 308 in accordance with the control of the control portion 301.

Furthermore, the driver 309 controls on/off of the first heater 91 in accordance with the control of the control portion 301. Similarly, the driver 310 controls on/off of the second heater 92 in accordance with the control of the control portion 301.

In order to perform image processing using the document reading apparatus of the embodiment according to the present invention, a user performs drawing so as to surround an arbitrary area using decoloring ink. The interior of the surrounded area serves as a specified area to be subjected to arbitrary image processing.

The decoloring ink gets denatured and decolorizes when it is heated, and various kinds of the decoloring ink have been proposed. In the present invention, ink which is colored so as to be visible, and which gets denatured and decolorizes when it is heated, is applicable as appropriate without restricting composition and characteristic of the decoloring ink. For example, Japanese Laid-Open Patent Publication No. 2004-018642 discloses a technology of the decoloring ink.

By reading a document drawn by the decoloring ink with the document reading apparatus of the present embodiment, it is possible to read an image without being affected by the decoloring ink, and to specify a specified area drawn by the decoloring ink. Thus, it is possible to apply arbitrary image processing to the image of the specified area.

The document reading apparatus is provided with the heater unit 90 for heating and decoloring the decoloring ink as described above. In order to detect a specified area using it, processing of reading a document drawn by the decoloring ink with the image reading apparatus is performed twice.

Here, a user firstly performs drawing so as to surround an arbitrary area using the decoloring ink with respect to the document. For example, using such as a magic marker which contains the decoloring ink therein, the user performs arbitrary drawing on the document. The area surrounded by the decoloring ink serves as a specified area.

Then, processing of determining the specified area is started by the document reading apparatus. In the document reading apparatus, an operation to start the processing of determining a specified area by decoloring ink is set in advance. By performing the operation in the document reading apparatus, the user is able to start the processing of determining the specified area.

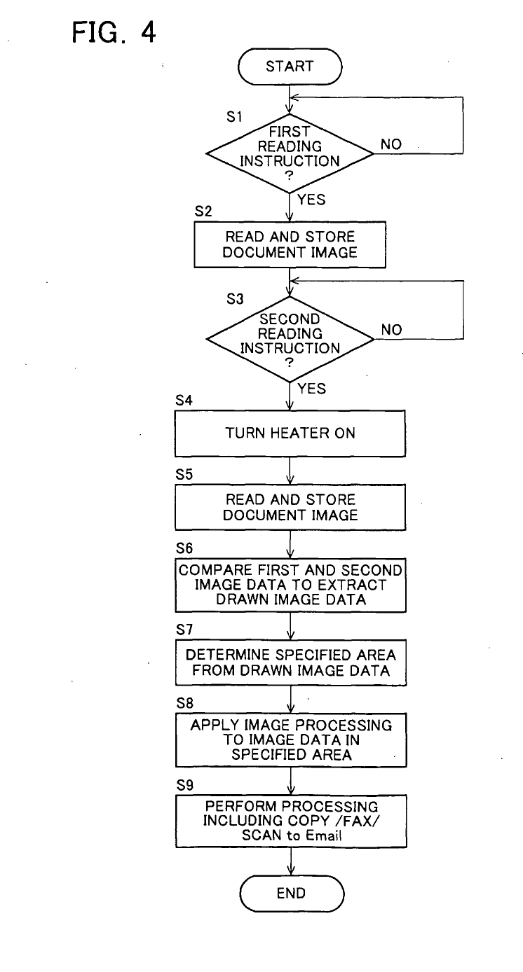

FIG. 4 is a flowchart for illustrating an example of processing of determining a specified area in the document reading apparatus of the present invention. Referring to the structure shown in FIG. 2, description will be hereinafter made.

When the processing of determining a specified area is started, the document reading apparatus 1 waits for a first document image reading instruction (step S1). The document image reading instruction can be carried out when a user sets the document in a document tray and depresses a start button on the document reading apparatus 1.

Then, in the document reading apparatus 1, when the first document image reading is instructed (step S1—YES), the document image is read while transporting the document at a normal transport speed, and image data thus read is stored (step S2).

After the first document image reading is finished, a second document image reading instruction is waited (step S3). In this case as well, the reading is instructed when the user sets the document again in the document tray and depresses the start button on the document reading apparatus 1. Although the operation of reading the document is performed such that the user sets the document twice in the document tray, a paper transport path and a control system may be provided so that the image reading is automatically performed twice by the document reading apparatus.

In the document reading apparatus 1, when the second document image reading is instructed (step S3—YES), the heater is turned on (step S4). In this case, when the document reading apparatus 1 is set in a single-sided reading mode, only the first heater 91 is turned on, and when a double-sided reading mode is set, the first heater and the second heater 92 are turned on.

Then, in the document reading apparatus 1, the document image is read by decreasing a speed of the document transport roller driving motor 308a to decrease a transport speed of the document, and image data thus read is stored (step S5). Here, by decreasing the transport speed of the document, a heating time by the heater is secured to sufficiently heat the document.

In addition, when a page number of a document an image of which is to be read is specified in advance, the document reading apparatus 1 stores the specified page number and may perform control for counting page numbers every time one document is transported, turning the heater on when the page specified in advance is transported, and turning the heater off when image reading on the specified page is completed. Such a control is applicable in a case where a plurality of pages are specified and the processing of determining a specified area is performed for the specified pages. The control enables to reduce power consumption.

Then, in the document reading apparatus 1, after the second document image reading is completed, the first image data is compared with the second image data, and drawn image data which is image data of a drawn part by the decoloring ink is extracted (step S6).

Here, it is possible to read image data of the document including the drawn part by the decoloring ink in the first image reading, and it is possible to read image data of the document in which the decoloring ink is erased by turning the heater on in the second image reading. Then, by comparing these image data, the image data of the drawn part by the decoloring ink (drawn image data) can be extracted (step S7). The extraction of the drawn image data can be carried out by the control portion using the first and the second image data stored in the storage portion 304.

By performing drawing so as to surround a specific area by the decoloring ink, the user is able to specify an interior of the surrounded area. In the document reading apparatus 1, whether or not the specific area is surrounded by the drawn image data by the decoloring ink is determined, and image data in the surrounded area is determined as a specified area. The processing of determining the specific area is also carried out by the control portion 301. Specific example of processing of determining the specific area will be described below.

Then, the document reading apparatus 1 carries out user-specified image processing with respect to image data in the specified area (step S8). Examples of the image processing which can be specified include image erasure, color change, zooming, and enhancement processing. It is also possible to change a color of the image data in the specified area. Moreover, it is also possible to perform, as the image edit, processing of erasing image data in the specified area to replace with correction data which is additionally transferred from an external device such as a PC. These image processing is carried out by the control portion 301 in accordance with the operation input to the operation panel portion 306.

Moreover, with respect to a page the specified area of which is determined, before the image processing is performed, the first read image data and the second read image data may be read from an image memory and displayed on a display portion such as a liquid crystal display provided on the operation panel 306, so as to prompt a user to make a confirm. Then, in the document reading apparatus 1, the image processing is carried out when the user confirms a display screen of the display portion and depresses an OK button. Alternatively, when the user depresses a cancel button at this time, the stored image data is cleared and the flow is started again to carry out series of processing again.

Then, in the document reading apparatus 1, copy, FAX transmission, SCAN to Email and the like, which are processing specified by a user, are carried out with respect to the image data after the image processing (step S9). These processing is carried out using the function of the communication portion 305 by the control of the control portion 301.

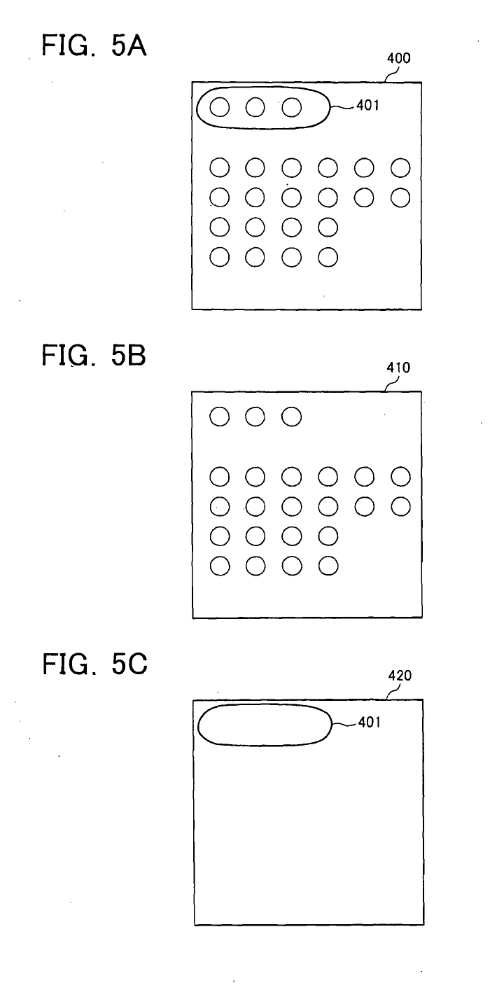

FIGS. 5A to 5C are views for specifically illustrating an example of processing of determining a specified area, wherein FIG. 5A shows an example of the result of first document image reading, FIG. 5B shows an example of the result of second document image reading, and FIG. 5C shows an example of extracted drawn image data. Referring to FIG. 3, description will be hereinafter made.

It is defined that image data 400 as shown in FIG. 5A can be obtained from the image processing portion 303 by the first document image reading processing. The image data 400 includes drawn image data 401 which is image data of a part drawn by decoloring ink.

In the second document image reading processing, a drawn part by the decoloring ink is erased with the heat of the heaters (the first heater 91 and the second heater 92), and image data 410 as shown in FIG. 5B can be obtained. These image data is temporarily held in the storage portion 304.

Then, the control portion 301 compares the first image data 400 and the second image data 410 to obtain image data of a different part between the first and second image data. As the image data of the different part, the drawn image data 401 as shown in FIG. 5C is obtained. Moreover, an image data range 420 shown in FIG. 5C shows a range of the image data obtained in the first and second reading. The image data range 420 corresponds to a range of image data for one-page document.

Then, the control portion 301 applies a search routine (described below) to the drawn image data 401, and determines whether or not the drawn image data 401 is drawn so as to form a specific surrounded area. When the surrounded area is formed, an interior of the surrounded area is determined as a specified area.

When comparing the first image data 400 and the second image data 410, the control portion 301 converts each of the image data 400 and 410 into binary image data of a low resolution at around 100 dpi, as pre-processing. FIGS. 5A and 5B show image data after the pre-processing.

Then, the control portion 301 performs EX-OR processing (comparing processing) with respect to all dots for each dot between the first image data 400 and the second image data 410. By the EX-OR processing, the different part among the two image data 400 and 410, that is, only the drawn image data 401 remains as the comparison result.

What is noted at the time of the EX-OR processing is that when a document is set in the document tray and an image of the document is read, there is position deviation of around 1 mm at maximum because no document image is read at the same position at all times.

Hence, at the time of comparing the first image data and the second image data, not only by comparing image data of dots at the same position of the two image data, but also by comparing, with respect to one dot of one of the image data, a dot of the other image data at the same position and a dot which is vertically and horizontally shifted by a few dots from the dot, respectively, a plurality of compared image data is obtained. Then, among the plurality of compared image data, the image data in which a different data becomes minimum is defined as the true drawn image data 401.

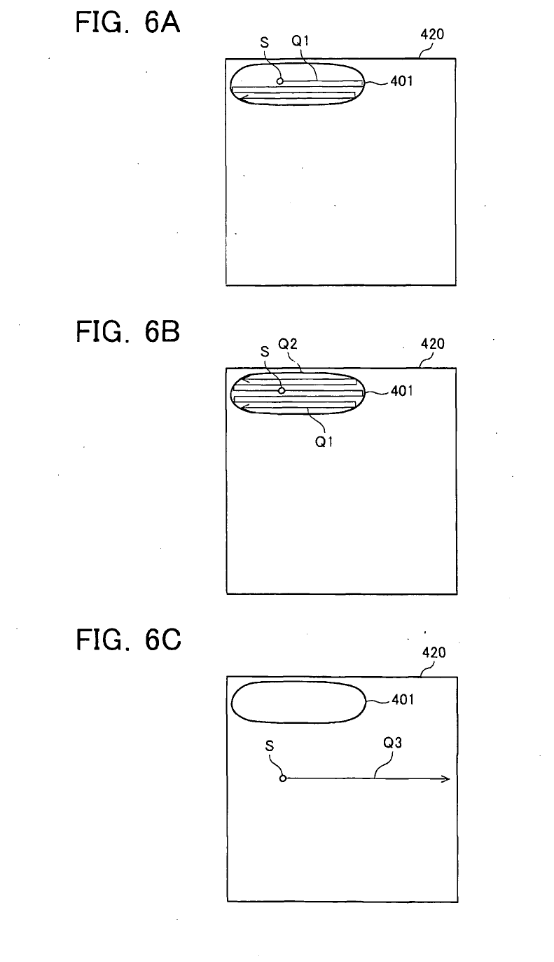

FIGS. 6A to 6C are views for illustrating an example of processing of determining a surrounded area of drawn image data. In the control portion 301 of the document reading apparatus 1, the drawn image data 401 is extracted by the aforementioned EX-OR processing, and thereafter the search routine is applied to the drawn image data so that whether or not a specific surrounded area is formed by the drawn image data 401 is determined.

The search routine is used to search whether or not there is an area surrounded by the drawn image data 401. In the search routine, the presence of the drawn image data 401 is searched by moving a dot for search. Here, the dot for search starts moving from an arbitrary dot in the image data area range 420 of one page and keeps moving by each dot to search whether or not reaching a dot of the drawn image data 401.

At this time, when the dot for search is not surrounded by the drawn image data 401, the dot for search eventually reaches the edge of the image data area range of one page. Moreover, when the dot for search is surrounded by the drawn image data 401, the dot for search will not reach the edge of the image data area range 420 of one page. Hence, by fully filling the interior of the surrounded area by the drawn image data 401 while moving the dot for search, a specified area subjected to image processing can be determined.

Moreover, in the routine for search, processing of moving the dot for search is performed twice for one start dot. In the first search, the movement is started from an arbitrary start dot to the right or left. In the second search, the movement is started from the same start dot to a direction opposite to that of the first search. When reaching the drawn image data 401 during the movement, the dot for search returns backward in the movement direction and moves to an upper or lower dot, followed by continuing the search by changing the lateral movement direction. The vertical movement direction in the second search is opposite to that in the first search. Moreover, when reaching the edge of the image data area range 420 during the movement, the search is finished. This is because it is possible to determine that there is no dot for search within the surrounded area by the drawn image data 401.

For example, as shown in FIG. 6A, the search is performed by sequentially moving the dot for search to the right direction from a start dot S. The search path is shown as Q1. When the dot for search reaches a dot of the drawn image data 401 while moving to the right direction, the dot for search moves to a lower dot before the dot of the drawn image data 401. Next, the dot for search moves on dots to the left direction sequentially. Here, similarly, when reaching a dot of the drawn image data 401, the dot for search returns to a backward dot and further moves to a lower dot, followed by moving to the right direction sequentially.

At the time of moving to the lower dot before the dot of the drawn image data 401, if the dot for search can not move because there is the drawn image data 401, it returns to a further backward dot and moves to a lower dot. When the dot for search can not move to the lower dot again, processing of returning to a further backward dot is repeated.

In this way, the search of the drawn image data is carried out, and when eventually the dot for search can not move anymore due to the presence of the drawn image data 401, it is found that the search area is surrounded by the drawn image data 401. The search processing so far is defined as the first search processing.

Next, as shown in FIG. 6B, the second search processing is performed after returning to the first start dot S. The search path is shown as Q2. In this search, the dot for search is moved to an opposite direction (a left direction herein) to that of the first search processing. When reaching the drawn image data 401, the dot for search returns to a backward dot to move to an upper dot in a direction opposite to that of the first search processing. Then, the dot for search is moved to the right direction. In this case as well, similar to the first search processing, when the dot for search can not move anymore due to the presence of the drawn image data 401 at the time of moving upward, processing of returning to a further backward dot is repeated.

In the second search processing, when eventually the dot for search can not move anymore due to the presence of the drawn image data 401, it is found that the search area is surrounded by the drawn image data 401.

In this way, by performing the first and the second search processing, when it is found that the search area is surrounded by the drawn image data 401, it can be determined as a surrounded area by the drawn image data 401. The interior of the surrounded area by the drawn image data 401 is a specified area specified by a user.

When moving downward before a dot of the drawn image data 401, by further moving to the same direction as that before the movement and converting the direction to a direction opposite to the movement direction when reaching the drawn image data 401, the search accuracy is further improved. For example, when the dot for search moving to the right direction reaches a dot of the drawn image data 401 and moves to a lower dot, the search is performed by continuously moving to the same right direction. When reaching a dot of the drawn image data 401, the direction is converted to the left direction so as to continue the search.

On the other hand, as shown in FIG. 6C, in a case where a start dot S is out of the surrounding of the drawn image data 401, when the dot for search is moved along the search path Q3, it reaches the edge of the image data range 420. Thus, it is found that the search range is not the interior of the surrounded area by the drawn image data 401, and the search processing by the start dot here is finished.

The aforementioned search processing enables to determine a surrounded area by drawn image data. Moreover, when a plurality of drawn image data is extracted, the search routine is carried out for each of the drawn image data, and thereby it is possible to determine a plurality of surrounded areas. In addition, as described above, the interior areas of the surrounded areas are defined as specified areas, and user-specified image processing is carried out for image data in the specified areas. It is also possible to apply processing such as copy, FAX transmission, and SCAN to Email to image data after the image processing.

### Embodiment 2

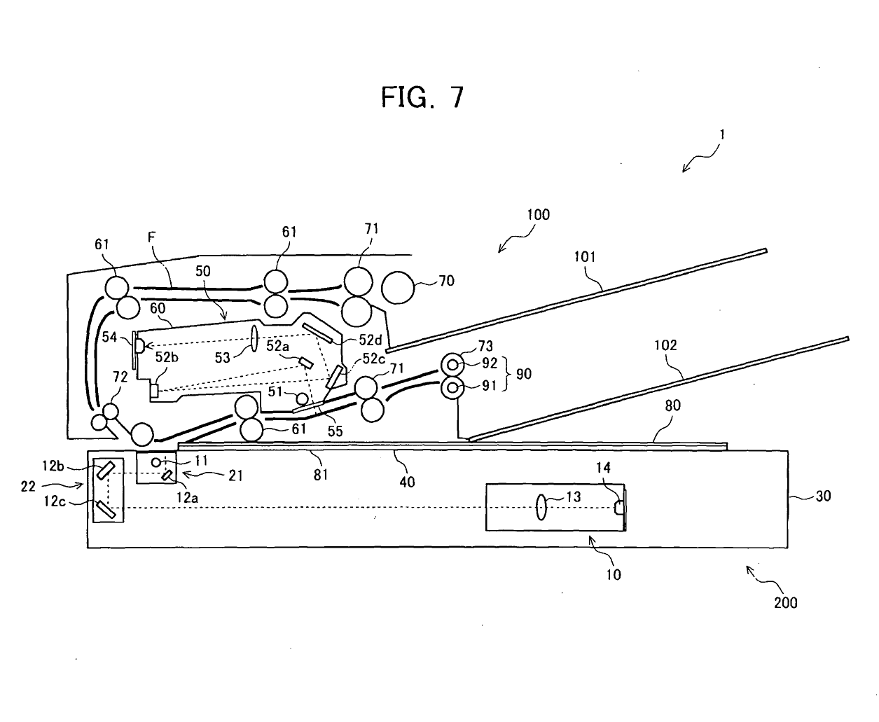

FIG. 7 is a schematic structural view for illustrating another embodiment of the document reading apparatus according to the present invention. Although the heater unit 90 composed of the first heater 91 and the second heater 92 is provided in a transport path in the upstream side of the image reading portion (the first image reading means 10 and the second image reading means 50) in the embodiment shown in FIG. 2, the heater unit is provided in the transport path in the downstream side of the image reading portion in the present embodiment. In the present embodiment, the heater unit is provided within the paper discharge roller 73, but without being restricted thereto, the heater unit 90 can be disposed at an appropriate position in the transport path in the downstream side of the image reading portion. The first heater 91 and the second heater 92 of the heater unit 90 are disposed so as to face each other across the transport path of a document. Moreover, the heater unit is capable of heating a front face and a rear face of a document selectively.

In the document reading apparatus 1 of the present embodiment, drawn image data colored by a coloring material of a specific color (for example, red) is extracted from image data read by the image reading portion. Then, a specified area surrounded by the drawn image data is determined to apply user-specified image processing with respect to image data in the specified area.

In order to perform image processing using the document reading apparatus 1 of the present embodiment, a user performs drawing so as to surround an arbitrary area using decoloring ink of a specific color. Then, a document drawn by the decoloring ink of the specific color is read by the document reading apparatus 1. After reading an image of the document, either one or both of the first heater 91 and the second heater 92 is energized when the document is transported toward the paper discharge roller 73, so that the document is heated and the decoloring ink is erased. By using the decoloring ink of the specific color, it is possible that a user who has not performed the writing by the decoloring ink views the specific area. Moreover, after the document reading, the user is able to immediately obtain the document in which the decoloring ink is erased.

In the document reading apparatus 1, drawn image data draw by the specific color is extracted from the image data read from the document. Then, a search routine similar to that of the first embodiment is carried out with respect to the drawn image data of the specific color, to search whether or not there is an area surrounded by the drawn image data of the specific color. When there is the area surrounded by the drawn image data of the specific color, the area is specified as the specified area. It is possible to apply user-specified image processing with respect to the specific area thus specified.

Since the document reading apparatus 1 shown in FIG. 7 has the same structure as that in the first embodiment except for the aforementioned characteristic point of the present embodiment, the repeated description thereof will be omitted. Furthermore, the structure of the function block view of FIG. 3 is also applicable to the present embodiment.

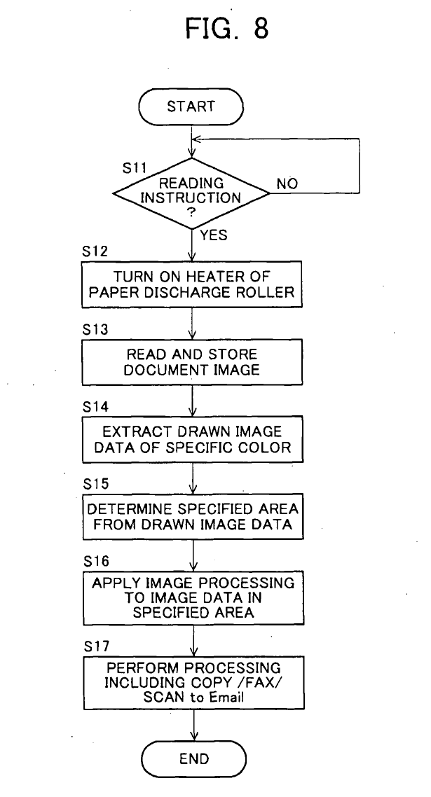

FIG. 8 is a flowchart for illustrating another example of processing of determining a specified area in the document reading apparatus according to the present invention. Referring to the structure shown in FIG. 7, description will be hereinafter made.

When processing of determining a specified area is started, the document reading apparatus 1 waits for an instruction to read a document image (step S11). The instruction to read the document image can be carried out when a user sets the document in the document tray and depresses a start button on the document reading apparatus 1.

Then, in the document reading apparatus 1, when reading of the document image is instructed (step S11—YES), the heater of the paper discharge roller is turned on (step S12). At this time, when the document reading apparatus 1 is set in a single-sided reading mode, only the first heater 91 is turned on, and when a double-sided reading mode is set, the first heater 91 and the second heater 92 are turned on. Then, the document image is read while transporting the document at a transport speed which is lower than a normal transport speed, and image data thus read is stored (step S13). The document the image of which has been read is heated by the heater on the transport path and a part drawn by the decoloring ink is decolorized.

When a page number of a document an image of which is to be read is specified in advance, the document reading apparatus 1 stores the specified page number and may perform control for counting page numbers every time one document is transported, turning the heater on when the page specified in advance is transported, and turning the heater off when image reading on the specified page is completed. Such a control is applicable when a plurality of pages are specified and the processing of determining a specified area is performed for the plurality of specified pages. The control enables to reduce power consumption.

After the reading of the document image is completed, drawn image data which is image data of a drawn part of a specific color is extracted from the read image data (step S14). The extraction of the drawn image data is carried out by the control portion 301.

By drawing so as to surround a specific area by the decoloring ink of the specific color, the user is able to specify an interior of the surrounded area. In the document reading apparatus 1, whether or not the specific area is surrounded by the drawn image data by the decoloring ink is determined, and image data in the surrounded area is determined as a specified area (step S15). The processing of determining the specified area is also carried out by the control portion 301.

Then, the document reading apparatus 1 carries out user-specified image processing for the image data in the specified area (step S16). Examples of the image processing which can be specified include, for example, image erasure, color change, zooming, enhancement processing, and the like. It is also possible to change a color of the image data in the specified area. Moreover, as the image edit, it is also possible to perform processing of erasing the image data in the specified area to replace with correction data which is additionally transferred from an external device such as a PC. Such image processing is carried out by the control portion 301 in accordance with the operation input to the operation panel portion 306.

Moreover, with respect to a page a specified area of which is determined, before the image processing is performed, the read image data may be read from an image memory and displayed on a display portion such as a liquid crystal display provided on the operation panel 306, so as to prompt a user to make a confirm. Then, in the document reading apparatus 1, the image processing is carried out when the user confirms a display screen of the display portion and depresses an OK button. Alternatively, when the user depresses a cancel button at this time, the stored image data is cleared and the flow is started again so as to carry out a series of processing again.

Then, in the document reading apparatus 1, user-specified processing, including copy, FAX transmission, SCAN to Email, and the like, is carried out with respect to the image data after the image processing (step S17). Such processing is carried out using the function of the communication portion 305 by the control of the control portion 301.

Note that, the structure as shown in FIG. 7 that the heater is provided in the transport path in the downstream side of the image reading portion, is also applicable to the first embodiment 1. In this case, the image reading portion performs an operation of reading a same document twice in a row, and in the first document image reading, the document an image of which has been read is heated by the heater, and in the second document image reading, the image of the document which has been heated by the heater in the first reading is read. Hence, it is possible to specify the specified area by the decoloring ink and carry out image processing for the specified area, similar to the first embodiment.

Next, a specific example of image processing for a specified area colored by decoloring ink will be described. Examples of the image processing carried out at step S8 in FIG. 4 (the first embodiment) and the image processing carried out at step S16 in FIG. 8 (the second embodiment) include, as described above, image erasure, color change, zooming, enhancement processing, and the like as the image processing which can be specified. In addition, it is also possible to change a color of image data of a specified area.

Moreover, as the image edit, it is also possible to perform processing of erasing image data of a specified area to synthesize correction data which is additionally transferred from an external device such as a PC. That is, the image data in the specified area can be replaced with another image data (correction data).

At this time, the correction data which is additionally transferred can be replaced by automatically zooming so as to match the specific area in size. This is realized such that a magnification of the correction data is defined and set depending on a ratio of a length of the specified area in an XY direction to a length of the correction data in an XY direction.

In addition, it is also possible to perform processing such that positions of a plurality of specified areas are registered and a plurality of correction data is sequentially replaced. In this case, ordinal numbers are added to the plurality of identified specified areas from the top to the bottom (or from the left to the right) and correction data which matches with an ordinal number is selected as data to be replaced.

Moreover, when text data is specified as the correction data, it is possible to convert into bitmap data to synthesize it with a specified area. Moreover, image data can be replaced in order to conceal personal information and confidential information, and in such a case, image data which shows that an original image is concealed may be prepared as the correction data so that the correction data is synthesized with the specified area.

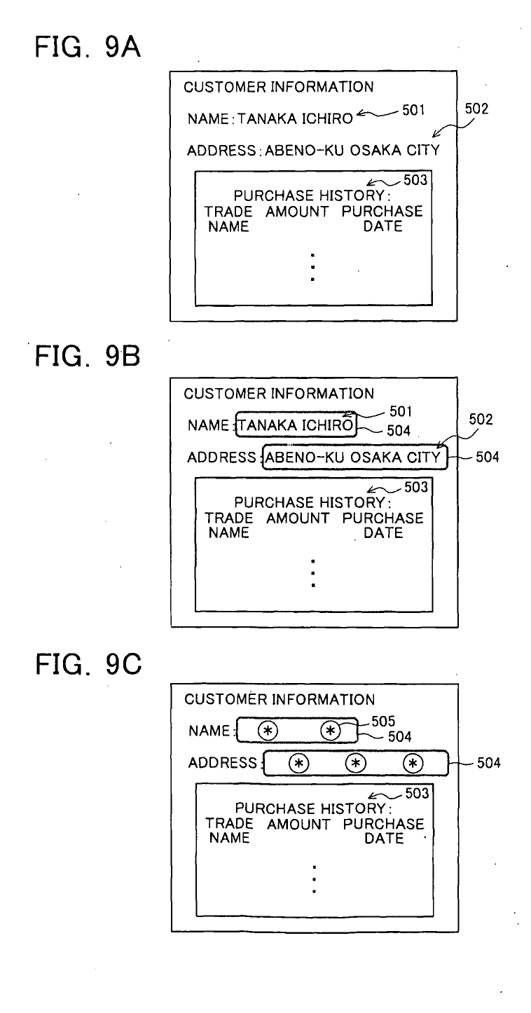

FIGS. 9A to 9C are views for illustrating an example of image processing for image data of a specified area, and show an example of processing of replacing image data to conceal an original image.

For example, it is defined that image data as shown in FIG. 9A includes customer information (herein a name and an address 502) and purchase history information 503. In addition, it is assumed that the customer information is concealed to copy only the purchase history information when such image data is copied.

In such a case, as shown in FIG. 9B, a user surrounds circumference of the name 501 and the address 502 on a document by decoloring ink. Then, the document reading apparatus is caused to read the document and to determine a specified area surrounded by the decoloring ink, so that an instruction to replace (synthesize) the specific area with correction data is input.

At this time, in the document reading apparatus 1, as shown in FIG. 9C, image data 505 which includes a word of “secret” is prepared as the correction data and stored in the storage portion 304, and processing of replacing original image data in the determined specified area with the image data 505 including a word of “secret” is performed. In this case, since the image data 505 including a word of “secret” shows that an original image is concealed, a user is able to know that the original image is concealed.

### Embodiment 3

An embodiment according to the document reading system of the present invention will be described. The embodiment of the document reading system includes means for realizing the function of the aforementioned first and second embodiments, and is able to carry out image processing similar to that of the embodiments.

In the document reading system according to the present embodiment, at least a specified area determination portion for determining a specified area surrounded by drawn image data by decoloring ink and an image processing portion for performing image processing with respect to the determined specified area are provided out of the document reading apparatus 1, and based on image data output from the document reading apparatus 1, the specified area is determined and specified image processing is carried out depending on a predetermined user operation.

The specified area determination portion and the image processing portion maybe realized by, for example, a control portion (a CPU, a memory and the like) of a digital multi-functional peripheral provided with the document reading apparatus 1. Moreover, it may be realized by a control portion (a CPU, a memory and the like) of an information processing apparatus such as a PC connected to the document reading apparatus 1.

The document reading apparatus 1 includes an image reading portion for reading an image of a document to generate image data, and a heater for heating the document to erase a drawn part on the document, which is drawn by a coloring material which gets denatured and decolorizes when it is heated. As the structure of the heater, any structure of aforementioned first and second embodiments are applicable. In this case, a drawn image data extraction portion for extracting drawn image data drawn by decoloring ink may be realized in the side of the document reading apparatus 1, or may be realized by an external device of the document reading apparatus 1.

Since the embodiment concerning the document reading system has the same function as that of the aforementioned embodiments of the document reading apparatus except for the above characteristic point, the repeated description thereof will be omitted.

According to the present invention, following effect can be obtained.

According to the present invention, the area specification to execute arbitrary image processing can be carried out by an easy operation without spoiling documents.

Furthermore, in the present invention, since it is possible to write into a document itself using decoloring ink which gets denatured and decolorizes when it is heated, a user is able to write to specify an arbitrary area directly on the document referring to the document, and there is no need of performing troublesome operations. Moreover, the document reading apparatus is provided with a heater and the decoloring ink is erased by heating the document with the heater, and thereby it is possible to perform the area specification easily without spoiling documents.

1. A document reading apparatus including an image reading portion for reading an image of a document to generate image data, comprising:
a heater for heating the document in a document transport path; and
an image data extraction portion which compares image data read by the image reading portion without performing heating by the heater and image data read by the image reading portion after performing the heating by the heater, to thereby extract drawn image data drawn by a coloring material which gets denatured and decolorizes when heated.

2. The document reading apparatus as defined in claim 1, wherein
when the image data extraction portion performs extraction of the drawn image data, the image reading portion performs an operation of reading the same document twice in a row, and
in a first document image reading, the document image is read without performing heating by the heater and in a second document image reading, the document image is read after performing the heating by the heater.

3. A document reading apparatus including an image reading portion for reading an image of a document to generate image data, comprising:
a heater for heating the document in a document transport path in a downstream side of the image reading portion; and
an image data extraction portion for extracting drawn image data drawn by a coloring material of a specific color from the image data read by the image reading portion.

4. The document reading apparatus as defined in claim 1 or 3, further comprising:
a specified area determination portion for determining, based on the drawn image data extracted by the image data extraction portion, a specified area surrounded by the drawn image data, and
an image processing portion for applying specified image processing for image data in the specified area determined by the specified area determination portion.

5. The document reading apparatus as defined in claim 3, further comprising:
a display portion for displaying the image data read by the image reading portion without performing heating by the heater and the image data read by the image reading portion after performing the heating by the heater, wherein
the image processing portion receives an operation input to confirm the image data displayed on the display portion and applies the specified image processing after the operation input.

6. The document reading apparatus as defined in claim 3, further comprising:
a display portion for displaying the image data read by the image reading portion, wherein
the image processing portion receives an operation input to confirm the image data displayed on the display portion and applies the specified image processing after the operation input.

7. The document reading apparatus as defined in claim 1 or 3, wherein
the heater is provided so as to be able to heat both of a front and a rear faces of the document.

8. The document reading apparatus as defined in claim 7, wherein
the heater heats the front face and the rear face of the document selectively.

9. The document reading apparatus as defined in claim 8, wherein
the heater is composed of a first heater for heating the front face of the document and a second heater for heating the rear face of the document, and
the first and the second heaters are disposed so as to face each other across a transport path of the document.

10. The document reading apparatus as defined in claim 1, wherein
a transport speed of the document when reading the document image after performing the heating by the heater is lower than a transport speed when reading the document image without performing the heating by the heater.

11. The document reading apparatus as defined in claim 1 or 3, wherein
when a page number of the document in which the drawn image data is to be extracted is specified, the heater is controlled so as to heat the document of the specified page number.

12. A document reading system, comprising:
a document reading apparatus which has an image reading portion for reading an image of a document to generate image data and a heater for heating the document and erasing a drawn part on the document, that is drawn by a coloring material which gets denatured and decolorizes when heated;
a drawn image data extraction portion for extracting drawn image data drawn by the coloring material;
a specified area determination portion for determining, based on the drawn image data extracted by the image data extraction portion, a specified area surrounded by the drawn image data; and
an image processing portion for applying specified image processing for image data in the specified area determined by the specified area determination portion.

13. The document reading system as defined in claim 12, wherein
the image processing portion erases the image data in the specified area to perform synthesizing with another image data.

14. The document reading system as defined in claim 13, wherein
the image processing portion performs synthesizing by automatically zooming the another image data so as to match the specified area in size.

15. The document reading system as defined in claim 13, wherein
the image processing portion performs synthesizing a plurality of the another image data with a plurality of the specified areas in a predetermined order.

16. The document reading system as defined in claim 13, wherein
the image processing portion converts text data into bitmap data and performs synthesizing the converted bitmap data as the another image data with the specified area.

17. The document reading system as defined in claim 13, wherein
the image processing portion performs synthesizing the another image data showing that an original image is concealed with the specified area.
